(19) United States
(12) Patent Application Publication
(10) Pub. No.: US 2013/0202009 A1
(43) Pub. Date: Aug. 8, 2013

(54) METHOD AND APPARATUS FOR DISPLAYING THE TEMPERATURE OF AN OBJECT

(71) Applicants: Balaji Murugan, Chennai (IN); Pydisetty Nageswara Rao, Hyderabad (IN); Ratheesh Cheran, Kannadiparamba (IN)

(72) Inventors: Balaji Murugan, Chennai (IN); Pydisetty Nageswara Rao, Hyderabad (IN); Ratheesh Cheran, Kannadiparamba (IN)

(73) Assignee: General Electric Company, Schenectady, NY (US)

(21) Appl. No.: 13/368,081

(22) Filed: Feb. 7, 2012

(51) Int. Cl. G01K 1/02

(52) U.S. Cl. 374/121; 374/E01.002

(57) ABSTRACT

A method and apparatus for displaying the temperature of an object using an infrared thermometer capable of displaying a measured temperature by projection onto the object being measured are disclosed.

### BACKGROUND OF THE INVENTION

The subject matter disclosed herein relates to infrared thermometers and, more particularly, to an infrared thermometer capable of displaying a measured temperature by projection onto the object being measured.

Infrared thermometers can be used to measure the temperature of a variety of objects without physical contact with the object Infrared light emitted from a section of the object is detected by a thermopile circuit located within the infrared thermometer. The thermopile circuit converts the infrared signal to an electrical signal, which is then correlated to a temperature. The measured temperature is typically displayed on a panel located on the surface of the infrared thermometer.

To properly measure the temperature of an object, the infrared thermometer should be held within a predetermined distance (e.g. 7 centimeters to 30 centimeters) from the object. When the infrared thermometer is properly positioned, a field of view with an acceptable radius is established. Unfortunately, users often do not position the infrared thermometer properly and an unacceptable field of view is established. The conventional solution to this problem is to simply notify the user of the predetermined distance, typically in an instruction manual. However, users often do not read the instruction manual or disregard the instructions and hold the infrared thermometer at an improper distance. This can result in inaccurate temperature measurements.

The discussion above is merely provided for general background information and is not intended to be used as an aid in determining the scope of the claimed subject matter.

### BRIEF DESCRIPTION OF THE INVENTION

A method and apparatus for displaying the temperature of an object using an infrared thermometer capable of displaying a measured temperature by projection onto the object being measured are disclosed. An advantage that may be realized in the practice of some disclosed embodiments is the ease of placement of the infrared thermometer at the correct distance from the objecting being measured. A further advantage is the simple visualization of the measured temperature on the object being measured.

In one exemplary embodiment, an infrared thermometer for projecting a temperature measurement onto an object being measured is disclosed. The infrared thermometer comprises an infrared thermopile with a field of view for determining a measured temperature of an object, a light path including a visible light source, an aperture, and a dynamic display disposed between the visible light source and the aperture, wherein the dynamic display produces a pattern indicative of the measured temperature, the pattern including an optically transparent pattern and an optically opaque pattern wherein visible light from the light source travels through the optically transparent pattern to project a displayed image that is indicative of the measured temperature through the aperture, and a display controller for controlling the dynamic display to alter the pattern to be indicative of the measured temperature.

In another exemplary embodiment, a method for measuring the temperature of an object is disclosed. The method comprises the steps of determining the measured temperature of a section of an object, generating on a display a pattern that is indicative of the measured temperature, the pattern including an optically transparent pattern and an optically opaque pattern, and projecting a displayed image that is indicative of the measured temperature onto the object by permitting visible light to travel from a light source through the optically transparent pattern to project the displayed image onto the object, wherein the displayed image is indicative of the measured temperature.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a depiction of an exemplary infrared thermometer being held at a proper, predetermined distance from the object being measured;

FIG. 2 is a depiction of an exemplary infrared thermometer being held too far from the object being measured;

FIG. 3 is a depiction of an exemplary infrared thermometer being held too close to the object being measured;

FIG. 4 is a schematic illustration of an exemplary light path for projecting a measured temperature onto an object;

FIGS. 5 and 6 show exemplary dynamic displays for use with the light path of FIG. 4;

FIG. 7 is a schematic diagram of select components of an exemplary infrared thermometer; and

FIG. 8 is a top view of an exemplary infrared thermometer.

### DETAILED DESCRIPTION OF THE INVENTION

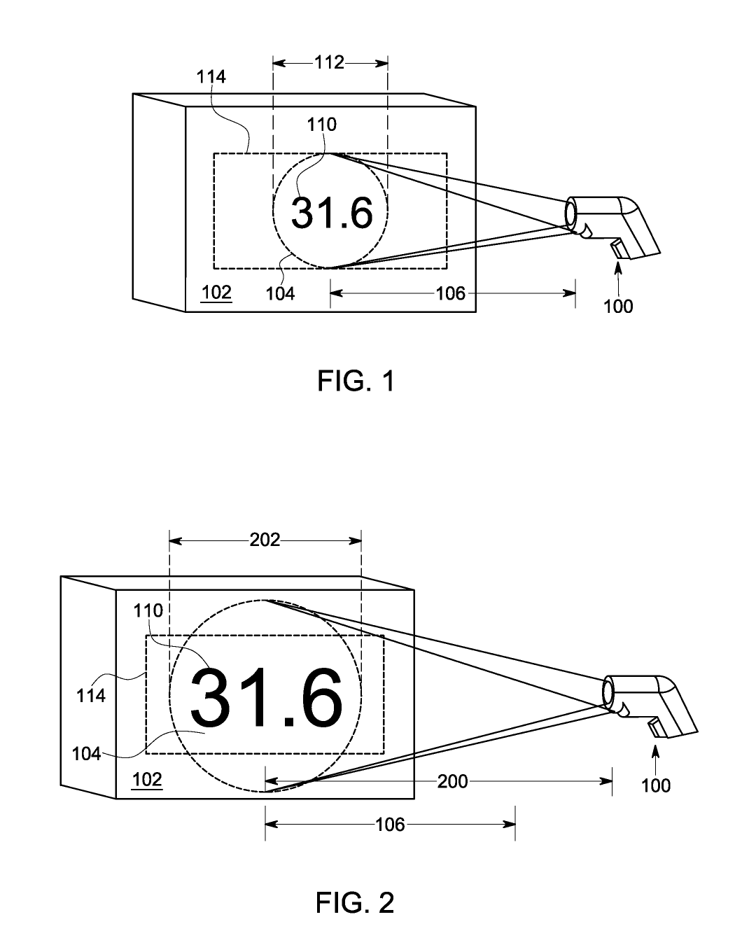

FIG. 1 depicts an exemplary infrared (IR) thermometer 100 measuring the temperature of a target section 114 of an object 102 by a non-contact process. Infrared thermometer 100 has a field of view 104 that, when placed at a predetermined distance 106 from the object 102, will properly measure the temperature of the section 114 of the object 102 that is within the field of view 104. In the embodiment of FIG. 1 the field of view 104 covers section 114 but avoids capturing other portions of object 102. Infrared thermometers typically calculate the average temperature within their field of view.

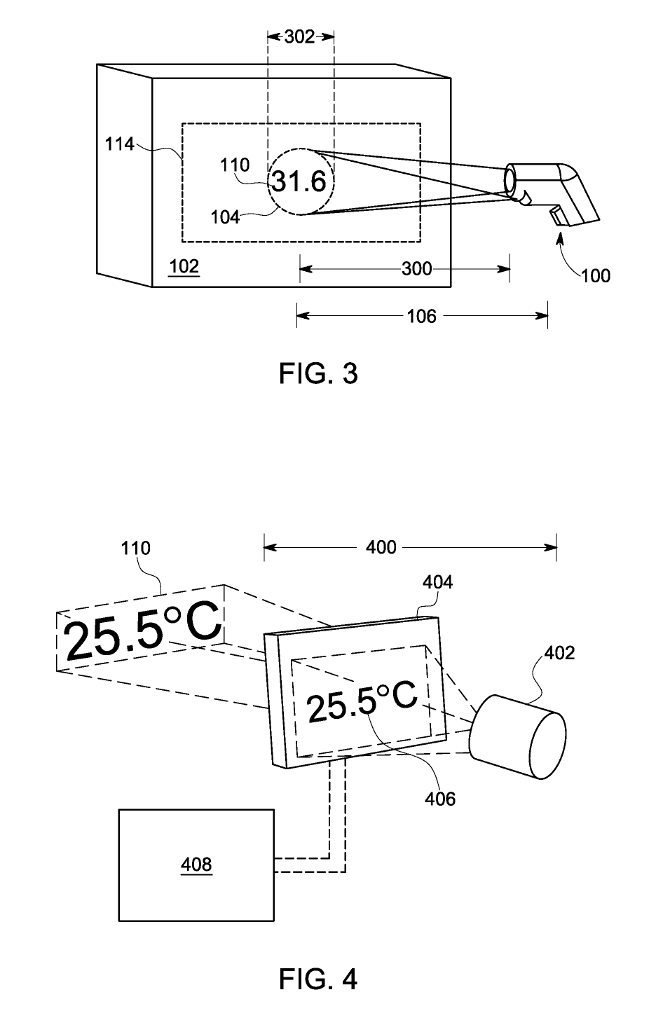

In one embodiment, infrared thermometer 100 is a handheld thermometer that projects a displayed image 110 of the measured temperature onto the object 102. The infrared thermometer 100 projects the displayed image 110 in a cone such that the projection size 112 increases as the distance between the infrared thermometer 100 and the object 102 is increased. In the embodiment depicted in FIG. 1, the infrared thermometer 100 is held at the predetermined distance 106 from the object 102 to produce the displayed image 110 with a specified projection size 112. For example, if the infrared thermometer 100 is calibrated to measure the temperature of an object 102 when held at a predetermined distance 106 of about 30 centimeters, then the predetermined projection size 112 of the displayed image 110 may be, for example, about 2.5 centimeters in height (a 12:1 ratio). It should be understood that the term “projection size” may refer to a predetermined height, width or area of the displayed image 110 as determined by the manufacturer of the infrared thermometer 100. In FIG. 1, the width of the projection size is illustrated. In the exemplary embodiment of FIG. 1, the section 114 of the object 102 that falls within the field of view 104 has an area of 6.25 square centimeters when the displayed image 110 has a size of 2.5 centimeters. In this fashion, the size of the field of view 104 can be properly controlled by monitoring the size of the displayed image 110. In the event that the distance between the infrared thermometer 100 and the object 102 is other than the predetermined distance 106 (e.g. greater or less than 30 centimeters), the displayed image 110 will have a projection size other than the predetermined projection size 112 (e.g. greater or less than 2.5 centimeters). See FIGS. 2 and 3. This variation in size provides an easily discernable indication to the user to show when the infrared thermometer 100 is being held at an inappropriate distance.

Infrared thermometers operate by collecting thermal radiation from an object. Accordingly, the precise field of view of a given infrared thermometer is not detectable by the user. An advantage that may be realized in the practice of some embodiments is the ability to approximate the boundaries of the field of view. Since the displayed image 110 overlaps with the field of view 104, the displayed image 110 provides a easily discernable indicator to aid the user in visualizing the field of view 104 and determining when the instrument is being improperly used.

FIG. 2 schematically depicts a situation where the infrared thermometer 100 is held at a distance 200 that is greater than the predetermined distance 106 for which the infrared thermometer 100 is calibrated. In the embodiment depicted, a user desires to measure the temperature of target section 114. Since infrared thermometer 100 projects visible light in a cone, and since distance 200 is relatively large, the projection size 202 of FIG. 2 is also large. This results in the displayed image 110 having a projection size 202 that is larger than the calibrated, predetermined projection size 112 (FIG. 1). The oversized projection size 202 provides a visual indicator to the user to move the infrared thermometer 100 closer to the object 102. For example, when the predetermined projection height is 2.5 centimeters and the observed projection height is 5 centimeters, then the user can easily determine that the infrared thermometer needs to be moved closer to section 114 in order to diminish the projection size 202 and thereby properly control the size of the field of view 104.

FIG. 3 schematically depicts a situation where the exemplary infrared thermometer 100 is held at a distance 300 that is less than than the predetermined distance 106 for which the infrared thermometer 100 is calibrated. This results in the displayed image 110 having a projection size 302 that is smaller than the predetermined projection size 112 (FIG. 1), thereby providing a visual indicator to the user to move the infrared thermometer 100 farther from the object 102.

FIG. 4 depicts one means for projecting the displayed image 110 onto the object 102. FIG. 4 illustrates an exemplary light path 400 that includes a light source 402. Light source 402 may be a coherent light source (e.g. laser light) or an incoherent light source (e.g. white light). Visible light from light source 402 travels to dynamic display 404 when it contacts pattern 406. The dynamic display 404 is configured to alter the pattern 406 in response to signals from the display controller 408. The pattern 406 is indicative of the measured temperature. Examples of pattern 406 include displays such as a numeric display which may or may not include temperature units including Celsius, Fahrenheit or Kelvin. In one embodiment, dynamic display 404 is a liquid crystal display (LCD). When the visible light contacts dynamic display 404 a portion travels through the pattern 406, exits the light path 400 at an aperture (not shown in FIG. 4) and provides displayed image 110.

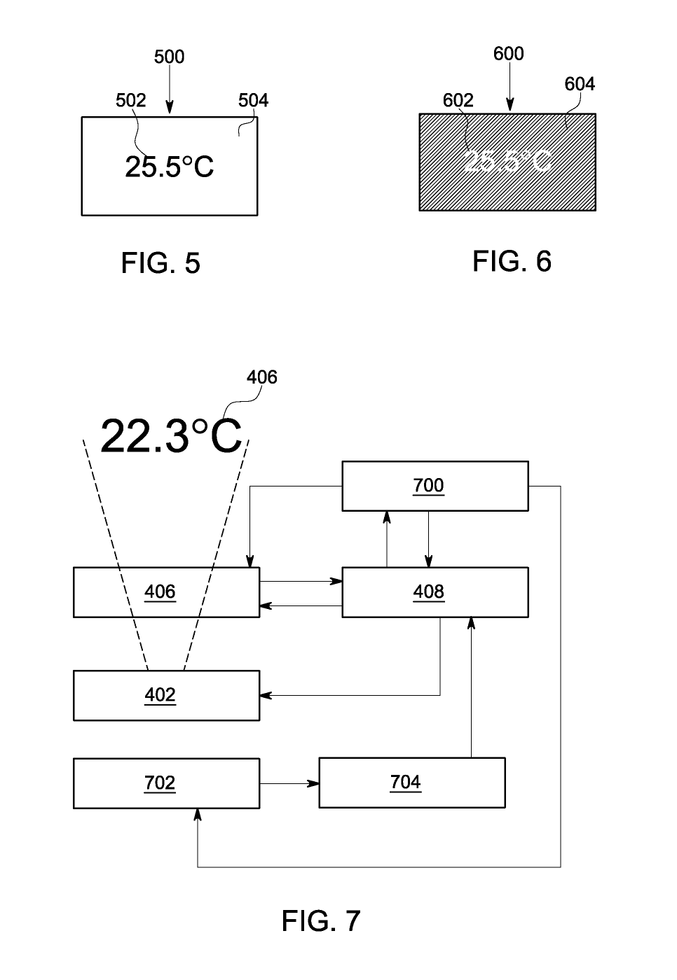

FIGS. 5 and 6 illustrate two dynamic displays wherein visible light travels through a pattern. FIG. 5 depicts pattern 500 which, in the exemplary embodiment, includes the measured temperature “25.5° C.” The pattern 500 includes an optically opaque pattern 502 which blocks visible light from light source 402 (not shown) surrounded by an optically transparent pattern 504. The resulting displayed image 110 will therefore include “25.5° C.” as a shadow surrounded by an illuminated section of light. FIG. 6 shows pattern 600 which includes optically transparent pattern 602 (“25.5° C.”) surrounded by optically opaque pattern 604 (schematically illustrated as a hatched pattern). Visible light from light source 402 (not shown) is blocked by optically opaque pattern 604 but passes through optically transparent pattern 602. The resulting displayed image 110 will therefore include “25.5° C.” as an illuminated reading.

In another embodiment, the dynamic display includes at least one movable stencil. In one such embodiment, two adjacent stencils are present which each include optically transparent patterns for the numbers zero through nine. By selectively rotating each stencil, any number between zero and ninety-nine can be projected. In another embodiment a third stencil provides additional digits. One or more non-numeric stencils may also be used to provide decimal places, positive or negative signs and/or a temperature unit.

FIG. 7 is a schematic depiction of various components of an exemplary infrared thermometer. The infrared thermometer shown in FIG. 7 is powered by a power supply 700. Suitable power supplies include an external power supply such as a 120 volt power cord or an internal power supply such as a battery. The infrared thermometer also includes a thermopile circuit 702 for converting infrared light emitted by an object into an analog electrical signal. This analog electrical signal is converted to a digital signal with analog-to-digital converter (ADC) 704 and the resulting digital signal is supplied to display controller 408. Display controller 408 controls the pattern shown on dynamic display 406. In one embodiment, display controller 408 is a microprocessor that also controls other aspects of the infrared thermometer including the power status (on or off) and/or the light intensity of light source 402. Alternatively, display controller 408 may also control the functioning of the thermopile circuit 702 including its power status and activation of its temperature measurement function.

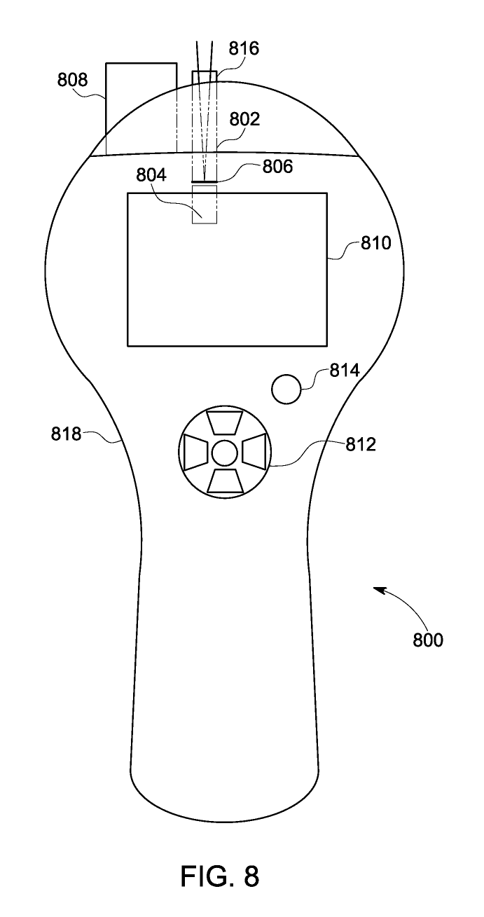

FIG. 8 is a top plan view of an exemplary handheld infrared thermometer 800. The infrared thermometer 800 has a light path 802 disposed within its housing 818. The light path 802 includes a light source 804 at a proximal end and an aperture 816 at a distal end. A dynamic display 806 is disposed between these two component. The infrared thermometer 800 includes an IR measurement window 808 for receiving infrared light from a target object and relaying this light to a thermopile (not shown). The exemplary infrared thermometer 800 also includes a display panel 810 on the external surface of its housing 818 which provides menu options to the user. Navigation buttons 812 are provided on the external surface of the housing 818 to permit the user to navigate these menus. Such menus provide access to functions such as instrument calibration, display of the measured temperature in a particular unit (e.g. ° C. or ° F.) and other conventional features. In one embodiment, display panel 810 is operatively connected both power supply 700 and display controller 408 (FIG. 7). The exemplary infrared thermometer 800 also includes measurement button 814. By depressing measuring button 814, the infrared thermometer 800 begins acquiring the temperature and projecting the displayed image as described elsewhere in this specification. In one embodiment a discrete temperature measurement is taken and displayed at the moment measurement button 814 is depressed and the resulting temperature is projected for a predetermined period of time (e.g. 5 seconds). In another embodiment the measurement button 814 is depressed and held and the temperature continually measured with the dynamic display 806 being updated accordingly for the duration of the depression of measurement button 814.

In view of the foregoing, embodiments of the infrared thermometer provide temperature measurements to an inspector that is performing an inspection. A technical effect is to improve the inspection process by providing a means to more easily place the infrared thermometer at the correct distance from the objecting being measured. A further technical effect is to simplify the visualization of the temperature on the object being measured.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An infrared thermometer for projecting a temperature measurement onto an object being measured, the infrared thermometer comprising:
an infrared thermopile with a field of view for determining a measured temperature of an object;
a light path including a visible light source, an aperture, and a dynamic display disposed between the visible light source and the aperture, wherein the dynamic display produces a pattern indicative of the measured temperature, the pattern including an optically transparent pattern and an optically opaque pattern wherein visible light from the light source travels through the optically transparent pattern to project a displayed image that is indicative of the measured temperature through the aperture; and
a display controller for controlling the dynamic display to alter the pattern to be indicative of the measured temperature.

2. The infrared thermometer as recited in claim 1, wherein the dynamic display is a liquid crystal display.

3. The infrared thermometer as recited in claim 2, wherein the optically opaque pattern is the measured temperature.

4. The infrared thermometer as recited in claim 2, wherein the optically transparent pattern is the measured temperature.

5. A handheld infrared thermometer for projecting a temperature measurement onto an object being measured, the thermometer comprising:
an infrared thermopile with a field of view for determining a measured temperature of an object;
a light path including a visible light source, an aperture, and a liquid crystal display disposed between the visible light source and the aperture, wherein the liquid crystal display produces a pattern indicative of the measured temperature, the pattern including an optically transparent pattern and an optically opaque pattern wherein visible light from the light source travels through the optically transparent pattern to project a displayed image that is indicative of the measured temperature through the aperture; and
a display controller for controlling the liquid crystal display to alter the pattern to be indicative of the measured temperature.

6. The handheld infrared thermometer as recited in claim 5, further comprising a power supply operatively connected to the infrared thermopile, the display controller and the liquid crystal display

7. The handheld infrared thermometer as recited in claim 5, further comprising an analog-to-digital converter for relaying the measured temperature from the infrared thermopile to the display controller.

8. The handheld infrared thermometer as recited in claim 5, further comprising an external surface with a display operatively connected to the display controller.

9. The handheld infrared thermometer as recited in claim 8, the external surface further comprising at least one measurement button.

10. The handheld infrared thermometer as recited in claim 9, the external surface further comprising at least one navigation button.

11. The handheld infrared thermometer as recited in claim 5, wherein the field of view and the displayed image overlap.

12. A method for measuring the temperature of an object, the method comprising the steps of:
determining the measured temperature of a section of an object;
generating on a display a pattern that is indicative of the measured temperature, the pattern including an optically transparent pattern and an optically opaque pattern; and
projecting a displayed image that is indicative of the measured temperature onto the object by permitting visible light to travel from a light source through the optically transparent pattern to project the displayed image onto the object, wherein the displayed image is indicative of the measured temperature.

13. The method as recited in claim 12, wherein the dynamic display is a liquid crystal display.

14. The method as recited in claim 12, wherein the optically opaque pattern is the measured temperature.

15. The method as recited in claim 12, wherein the optically transparent pattern is the measured temperature.

16. The method as recited in claim 12, further comprising the step of selecting the predetermined size of the displayed image.

17. The method as recited in claim 12, further comprising the step of depressing a measurement button wherein the temperature of the section is continually measured and the displayed image is continually updated while the measurement button is depressed.
